(19) United States
(12) Patent Application Publication
(10) Pub. No.: US 2006/0129374 A1
(43) Pub. Date: Jun. 15, 2006

(54) Apparatus and method for apparatus mediating voltage levels between an emulation unit and a target processor

(76) Inventors: Lee A. Larson, Katy, TX (US); Ronald L. Lerner, Houston, TX (US); Roger W. Strane, Irwin, PA (US)

Correspondence Address: TEXAS INSTRUMENTS INCORPORATED, P O BOX 655474, M/S 3999, DALLAS, TX, 75265, US

(21) Appl. No.: 11/012,840

(22) Filed: Dec. 15, 2004

(51) Int. Cl. G06F 9/455

(52) U.S. Cl. 703/25

(57) ABSTRACT

An emulation unit/target processor interface apparatus senses the target processor I/O voltages using filters to reduce the noise level and provides the rest of the interface apparatus with a target reference voltage level. The reference voltage is used to create threshold voltages, termination voltages and drive levels appropriate to provide an interface with the target processor. Power loss in the target processor is also detected so that drive signals can be removed from the target processor to avoid damaging the target processor and to prevent the target processor from being energized by the emulation unit.

### BACKGROUND OF THE INVENTION

1. Field of the Invention

This invention relates generally to digital processing units and more particularly, to the test and debug of a target processor by an emulation unit.

2. Background of the Invention

In the past, testing and debugging digital signal processors was performed using interface electronics with a fixed voltage capability. Older test and debug units such as emulation units were designed to work only with 5 volt digital signal target processors. When the digital signal processor under test operates with a different supply voltage, the user has to provide interface logic apparatus to translate between the older style emulation unit signal levels and the signal levels of the processor under test. Emulation units soon started using 3.3 volt logic apparatus with a tolerance of 5 volts which reduced the effort in providing interface apparatus for the digital signal processor.

Advanced emulators are designed to operate over a wide range of supply voltages, typically between 0.5 volts and 5 volts. To determine the operating voltage of the emulation unit, a sense pin is provided to detect the target processor I/O voltage and to scale the emulation unit drive signals and set the logic threshold voltages.

A need has therefore been felt for apparatus and an associated method having the feature of providing improved test and debug capabilities. It is a further feature of the apparatus and associated method to provide an emulation unit that is able to sense the voltage of the target processor and adjust the output voltage levels of an emulation unit. It is yet another feature of the apparatus and associated method to create a threshold voltage for received signals that is based on the target I/O voltage level. It is a still further feature of the apparatus and associated method to provide an emulation unit that can detect the loss of power by the target processor. It is still a further feature of the apparatus and associated method to provide a clamping voltage to protect the emulation unit against electrostatic discharge. It would be a more particular feature of the apparatus and associated method to limit voltage excursions by signals from the target processor.

### SUMMARY OF THE INVENTION

The aforementioned and other features are accomplished, according to the present invention, by providing an interface circuit associated with the emulation unit to sense the target I/O voltage, to limit the output voltage of the emulation unit to a maximum value, to provide a suitable threshold voltage and a clamping voltage, and to detect the loss of target power.

Other features and advantages of present invention will be more clearly understood upon reading of the following description and the accompanying drawings and the claims.

### BRIEF DESCRIPTION OF THE DRAWINGS

FIG. 1 is a block diagram of the interface circuit invention illustrating the relationship of the various components of the present invention.

FIG. 2 is a schematic diagram of the voltage sensing device for sensing the target voltage according to the present invention.

FIG. 3 is a schematic diagram of the clamp voltage generator according to the present invention.

FIG. 4 is a schematic diagram of the target voltage limiting circuit according to the present invention.

FIG. 5 is a schematic diagram of the threshold generation circuit according to the present invention.

FIG. 6 is a schematic diagram of the power loss detection circuit according to the present invention.

FIG. 7 is a schematic diagram of the input comparator circuit according to the present invention.

FIG. 8 is diagram of the output switches according to the present invention.

### DESCRIPTION OF THE PREFERRED EMBODIMENT

1. Detailed Description of the Figures

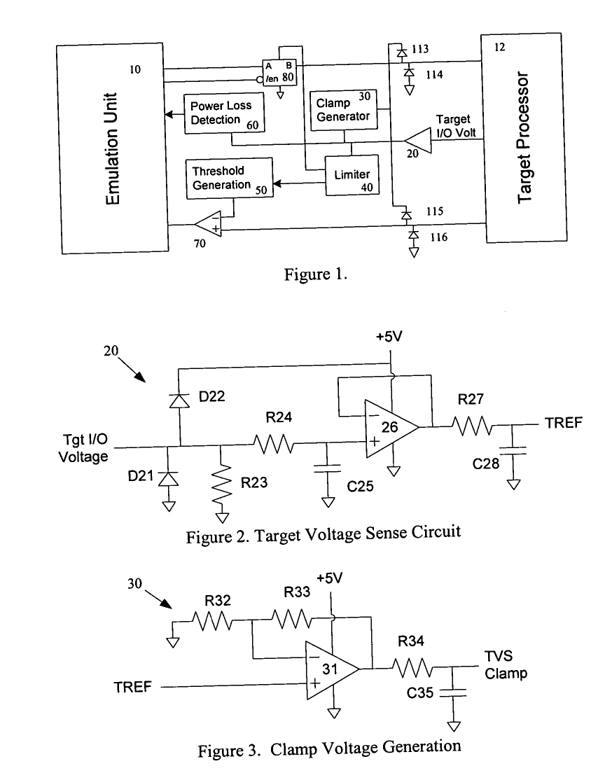

Referring to FIG. 1, the block diagram of the interface circuit between the emulation unit 10 and the target processor 12, according to the present invention, is shown. The output terminals of the emulation unit 12 are coupled to an input terminal of an FET output switch 80 and to the control terminals of the FET switch 80. The output terminals of the FET switch are coupled to the target processor 12, through ESD protection diode 114 connected to ground potential, and through ESD protection diode 113 connected to an output terminal of clamp generator 30. The target processor applies the I/O voltage to an input terminal of the target sensing device 20. The output voltage of the target sensing device is coupled to the clamp generator 30, to the limiter 40, to the power loss detection 60. The power loss detection 60 applies an output signal to the emulation unit 10. The limiter 40 applies an output voltage to the threshold generation unit 50 and output signal to the power terminal of FET output switch 80. The target processor output terminals are coupled to the positive terminal of comparator 70, are coupled through diode 116 to ground potential, and are coupled through diode 115 to the output terminal of clamp generator 30. An output terminal of the threshold generation unit is coupled to a negative input terminal of comparator 70.

Referring to FIG. 2, the schematic diagram of the target voltage sense circuit 20 is shown. The I/O voltage from the target processor 12 is applied through ESD protection diode 21 to ground potential, through ESD protection diode 22 to the 5 volt supply voltage, through resistor 23 to ground potential, and to a first terminal of resistor 24. A second terminal of resistor 24 is coupled to the positive terminal of operational amplifier 26 and through capacitor 25 to the ground potential. The power terminal of operational amplifier 26 is coupled to a 5 volt supply voltage. The output terminal of operational amplifier 26 is coupled to the negative input terminal of operation amplifier 26, and to a first terminal of resistor 27. The second terminal of resistor 27 is coupled through capacitor 28 to ground potential and provides the TREF signal.

Referring to FIG. 3, a schematic diagram of the clamp voltage generation circuit 30 is shown. The TREF signal is applied to the positive terminal of an operational amplifier 31. The negative input terminal of the operational amplifier 31 is coupled to through resistor 32 to the ground potential and through resistor 33 to the output terminal of operational amplifier 31.

The power terminal of operational amplifier 31 is coupled to a 5 volt supply voltage. The output terminal of operational amplifier 31 is coupled through resistor 34 to the terminal providing the TVS CLAMP signal and to a first terminal of capacitor 35, the second terminal of capacitor 35 being coupled to ground potential.

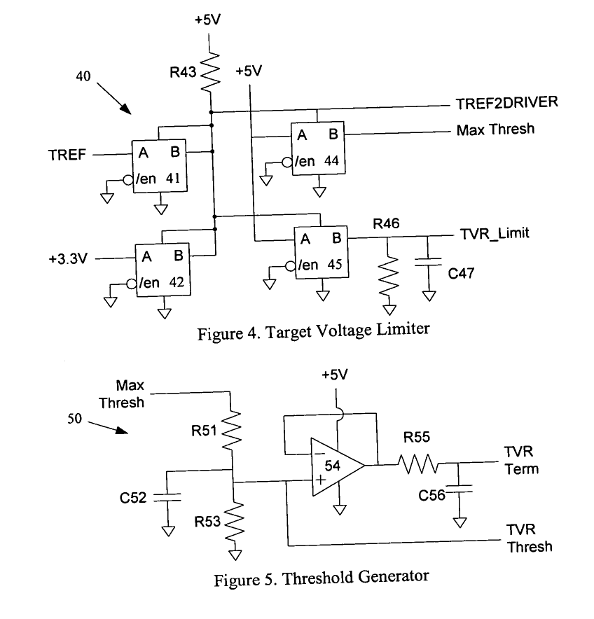

Referring to FIG. 4, a schematic diagram of the target voltage limiter circuit 40, according to the present invention, is shown. The TREF signal is applied to an input terminal of output switch 41 while the ground potential is applied to the control terminal of output switch 41. A 5 volt supply voltage is coupled through resistor 43 to the substrates of output switches 41, 42, 44 and 45, and to the output terminals of output switches 41 and 42. This same signal is output as TREF2DRIVER. A 5 volt supply is coupled to the input terminals of output switches 44 and 45. The ground potential is applied to control terminals of output switches 42, 44 and 45 are coupled to the ground potential. The output terminal of output switch 44 provides the MAX THRESH signal while the output terminal of output switch 45 is coupled through resistor 46 to ground potential, through capacitor 47 to ground potential, and supplies the TVR_LIMIT signal.

Referring to FIG. 5, a schematic diagram of the threshold generator circuit 50, according to the present invention is shown. The MAX THRESH signal is applied through resistor 51 to grounded capacitor 52, to grounded resistor 53, to the positive input terminal of operational amplifier 54, and to the terminal providing the TVR THRESH signal. The power terminal of operational amplifier 54 is coupled to a 5 volt supply. The output terminal of the operational amplifier 54 is coupled to the negative input terminal of operational amplifier 54, and is coupled through resistor 55 to grounded capacitor 56 and to the TVR TERM signal terminal.

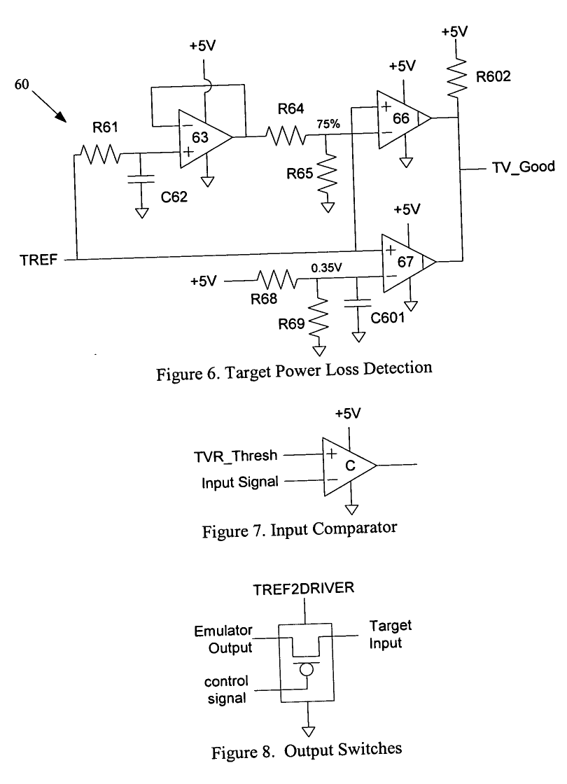

Referring to FIG. 6, a schematic diagram of the target power loss detection unit 60, according to the present invention, is shown. The TREF signal is applied to a positive input terminal of comparator 67, to a positive input terminal of comparator 66, and through resistor 61 to a terminal of grounded capacitor 62 and the positive input terminal of operational amplifier 63. The power terminals of operational amplifier 63 and comparators 66, and 67 are coupled to a 5 volt supply. The output terminal of operational amplifier 63 is coupled to a negative input terminal of operational amplifier comparator 63 and through resistor 64 to a negative input terminal of comparator 66 and to grounded resistor 65. The negative input terminal of comparator 67 is coupled through capacitor 601 to ground potential, through resistor 69 to the ground potential, and through resistor 68 to a 5 volt power supply. The output terminals of comparators 66 and 67 are coupled together to provide a TV_GOOD signals and are coupled through resistor 602 to a 5 volt supply.

Referring to FIG. 7, the configuration of the input comparator 70 is shown. The input comparator 70 has the TVR_THRESH signal is applied to the positive input terminal of comparator 70, while the INPUT signal is applied to the negative input terminal of comparator 70. The power terminal of comparator 70 is coupled to a 5 volt supply.

Referring to FIG. 8, the configuration of the output switch 80 is shown. An input signal (e.g., from the emulation unit signals) is applied to an input terminal of FET switch 80 while the output terminal FET switch 80 provides the output signal (e.g., to the target processor. The control terminal of the FET switch has the control signal applied thereto. The TREFZDRIVER signal is applied to the power terminal of the FET switch. The FET switch limits the output voltage to TREF2DRIVER-1V.

Operation of the Preferred Embodiment

Referring once again to interface apparatus of FIG. 1, the inputs to the apparatus are protected by electrostatic discharge (ESD) clamp diodes. The target I/O voltage is sensed, filtered and fed to the remaining analog circuitry. The clamp generator generates the ESD clamping voltage for input and output signals. The limiter sets the maximum voltage into the threshold circuit. The threshold generator creates threshold and termination voltages. The power loss detection unit senses when the target voltage is off. As will be clear, the signal path between the target processor and the emulation unit will actually be comprised of a multiplicity of paths, i.e., a multiplicity of output switches will be used.

Referring once again to the target voltage sensing circuit shown in FIG. 2, the input signal to this circuit has the ESD protection diodes clamped to ground and to the op amp power supply. The input circuit has a high value resistor 23 coupled to ground so that when disconnected, the output TREF signal will go to zero volts. The input signal is applied to the low pass-filter of resistor 24 and capacitor 25, buffered by op amp 26, and then applied to low pass of resistor 27 and capacitor 28. The output TREF signal is a buffered and filtered equivalent of the target voltage. The time constants are chosen to reduce noise, but allow a reasonable response time when the voltage is turned on.

Referring once again to the clamp voltage generation circuit shown in FIG. 3, this circuit multiplies the target reference voltage, TREF, by 1.33 to increase the clamping voltage for the ESD diodes on all of the other input and output signals. The clamping voltage is applied to a low pass filter and is decoupled.

Referring once again to the target voltage limiter shown in FIG. 4, this circuit routes TREF through FET switch 41. It also routes the 3.30 volt power supply through FET switch 42. These two switches are in the same package and share the same substrate. The output voltage is limited to the lesser of the two input signals plus approximately 1 volt. This voltage, TREF2DRIVER, is used to power FET switches 44 and 45, as well as the FET output switch 80. The outputs of those switches are limited to TREF2DRIVER-1 volt. The output from FET switch 45 is low pass filtered by resistor 46 and capacitor 47 to become TUR_LIMIT. The TUR_Limit voltage can be used for pulling up target signals if required.

Referring once again to the threshold generator as shown in FIG. 5, this circuit takes the MAX_THRESH voltage and divides the voltage using two resistors 51 and 53 and a low pass filter including capacitor 52 to provide the TVR THRESHOLD signal. For all target voltages 3.3 volts and less, the threshold is set to 50% of the target voltage, the standard CMOS threshold. For target voltages greater than 3.3 volts, typically 5 volts, the threshold is set to 1.65 volts, which is close to the nominal 1.4 volt TTL threshold voltage level. The TVR_THRESHOLD is buffered, passed through a low pass filter and is decoupled using resistor 55 and capacitor 56 to generate the TERMINATION voltage, TVR_TERM. The terminal voltage can be used to terminate signals from target processor to the Target I/O voltage/2 to minimize the DC current loading.

Referring to the power loss detection circuit shown in FIG. 6, this circuit has two methods for detecting power loss. The first method is by comparing the target reference voltage to a fixed threshold of 0.35 volts. The threshold is provided by resistors 68 and 69, capacitor 601 providing low pass filtering. The second method of power loss detection is to detect a drop in power from the existing level. This detection is accomplished by filtering the TREF voltage with a low pass filter of resistor 61 and capacitor 62 with a very large time constant. This signal is buffered and divided by resistors 64 and 65 to 75% of the target voltage. The comparator detects drops in the target voltage exceeding 25% of nominal. When the target processor loses power, the emulation unit is notified by an interrupt signal in order for the software to make appropriate adjustments.

Referring to the input comparator circuit shown in FIG. 7, all of the active signals from the target are routed to input comparators to sense whether they are high or low. The threshold levels are derived from the target I/O voltage.

Referring to the output switch logic as shown in FIG. 8, the input signals are applied to the target processor through FET switches in order to provide voltage level adjustment. The FET switches are controlled by control signals applied to the FET control terminal. The FET transistors can be used to stop the exchange of data signals between the emulation unit and the target processor. The FET switches are used in this implementation for several reasons, these switches have virtually no propagation delay, consume virtually no power, and the output voltage is constrained to no greater than the supply voltage minus the gate to drain voltage. Because the TREF2DRIVER voltage is applied to the power supply input of the FET switches, the output voltage can not exceed the target I/O voltage.

As will be clear, the interface can be implemented using analog-to-digital converter to sense the target I/O voltage. A digital-to analog converter or programmable power supply can be programmed to supply the output voltage levels and threshold levels.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. An interface unit providing an interface for the exchange of signals between an emulation unit and a target processor, the interface unit comprising:
a sense unit responsive to an I/O voltage level of the target processor;
threshold generation unit responsive to a signal from the sense unit, the threshold generation unit receiving output signals from the target processor, the threshold generation unit applying input signals having preselected amplitudes to the emulation unit; and
an amplifier unit receiving output signals from the target processor, the amplifier unit applying signals to the emulation unit, the amplifier unit having a signal from the sense unit applied thereto, the signal from the sense unit determining the logic levels of signals applied to the emulation unit.

2. The interface unit as recited in claim 1 further comprising:
a power loss detection unit having a signal from the sense unit applied thereto, the power loss detection unit providing a signal to the emulation unit indicating loss of target processor power.

3. The interface unit as recited in claim 1 further comprising:
a clamp generator receiving an output signal from the sense unit;
a first diode coupled between ground and a conductor applying input signals to the target processor;
a second diode coupled between the conductor applying input signals to the target processor and the clamp generator output terminal;
a third diode coupled between ground potential and a conductor receiving output signals from the target processor; and
a fourth diode coupled between the conductor receiving output signals from the target processor and the output terminal of the clamp generator.

4. The interface unit as recited in claim 1 further comprising a limiter unit, the limiter unit coupled between the sense unit and the threshold generation unit.

5. The interface unit as recited in claim 4 wherein the limiter unit generates the maximum input voltage to the threshold generating unit.

6. A method for providing an interface for the exchange of signals between an emulation unit and a target processor, the method comprising:
sensing the value of the supply voltage of the target processor and generating sense signal in response;
using the sense signal, determining the amplitude of signals from the target processor applied to the emulation unit; and
using the sense signal, determining the amplitude of the signals from the emulation unit applied to the target processor.

7. The method as recited in claim 6 further comprising:
using the sense signal, clamping the signals on the conductor applying signals to the target processor and on the conductor receiving signals from the target processor between a predetermined value and ground potential.

8. The method as recited in claim 6 further comprising:
using the sensing of the target processor supply voltage to identify a failing target power supply, providing a signal to the emulation unit signaling the failing power supply.

9. Apparatus of buffering the amplitude of the signals exchanged between an emulation unit and a target processor, the apparatus comprising:
a sense unit for sensing the supply voltage of the target processor, the sense amplifier generating a sense signal in response to the amplitude of the supply voltage;
a first amplifier unit having an input coupled to the emulation unit and an output coupled to the target processor, the first amplifier determining the amplitude of the signal applied to the target unit in response to the sense signal; and
a second amplifier having an input terminal coupled to the target processor and an output terminal coupled to the emulation unit, the second amplifier determining the amplitude of signal applied to the emulation unit in response to the sense signal.

10. The apparatus as recited in claim 9 further comprising:
a limiter unit coupled to the sense unit; and
a threshold generator receiving signals from the limiter unit and applying signals to the second sense amplifier.

11. The apparatus as recited in claim 9 further comprising a power loss detection system coupled to the sense unit, the power loss detection unit applying a predetermined signal to the emulation unit when the target processor is failing.

12. The apparatus as recited in claim 9 further comprising:
a clamp voltage generator responsive to the sense signal for generating a clamp voltage,
a first diode clamp coupled to the target processor input terminal, the first diode clamp coupled to the clamp voltage generator;
a second diode clamp coupled to the target processor output terminal, the second diode clamp coupled to the ground potential.

13. The apparatus as recited in claim 12 wherein the output voltage of the clamp voltage generator determines the maximum voltage of the first diode clamp and the second diode clamp.

14. The apparatus as recited in claim 13 wherein the diode clamps provide electrostatic voltage protection.
